(19) United States
(12) Patent Application Publication
(10) Pub. No.: US 2002/0194970 A1
(43) Pub. Date: Dec. 26, 2002

(54) Apparatus and method for cutting gel and other sheet materials

(76) Inventor: Joseph H. Evreniadis, Chicago, IL (US)

Correspondence Address: John H. Coult, Suite 100, 1129 W Wellington Ave., Chicago, IL, 60657, US

(21) Appl. No.: 09/891,013

(22) Filed: Jun. 25, 2001

(51) Int. Cl. B26D 7/00

(52) U.S. Cl. 83/34; 83/215; 83/436.3; 83/574; 83/614

(57) ABSTRACT

Manually operable apparatus for cutting gel or other sheet material comprises a cutting table and a longitudinally reciprocable traveling bridge mounting a transversely translatable cutter carriage supporting a cutter assembly for manually selective movement to any position on the cutting table. The cutter assembly is employed for making longitudinal as well as transverse cuts of the sheet material. An associated method is also disclosed.

### BACKGROUND OF THE INVENTION

This invention relates to apparatus for manually cutting strips and rectangular sections of material from a continuous or discrete web of paper, plastic, or other sheet material. It is known to have extraordinary utility for cutting gel and will be described in that context.

Gel material used to color and modify lighting on movie and stage sets, for example, is available in a multitude of colors and is shipped on three and four foot rolls. Lighting technicians traditionally cut the gel material from the rolls using a razor and straight edge or other common hand tools. This procedure is laborious, time-consuming, inaccurate and wasteful of the sheet material being cut. Some sheet materials, such as gel, with which the invention may be used are very costly, and waste thereof is desired to be avoided.

### OBJECTS OF THE INVENTION

It is an object of the invention to provide apparatus for cutting gel and other sheet materials which is easy and rapid in use, and precise and accurate in operation.

It is another object to provide such apparatus which is highly versatile, being capable of cutting long strips or discrete sections from a continuous web of material, or for cutting smaller sections from a larger section of loose sheet material.

It is yet another object to provide such apparatus which is rugged and reliable.

### DESCRIPTION OF THE FIGURES

FIGS. 1-3 are side, top and end views of apparatus constructed in accordance with the teachings of the invention;

FIGS. 4-7 detail a traveling bridge assembly comprising part of the FIGS. 1-3 assembly;

FIGS. 8-9 detail a roller assembly comprising part of the FIGS. 4-7 traveling bridge assembly;

FIGS. 10, 10A and 11 detail a clamping assembly comprising part of the FIGS. 1-3 apparatus;

FIGS. 12-15 illustrate a cutter assembly carried by the traveling bridge assembly;

FIGS. 16-17 detail a table idler roller assembly similar to the FIGS. 8-9 roller assembly; and

FIGS. 18-19 illustrate a roller support for the FIGS. 16-17 roller.

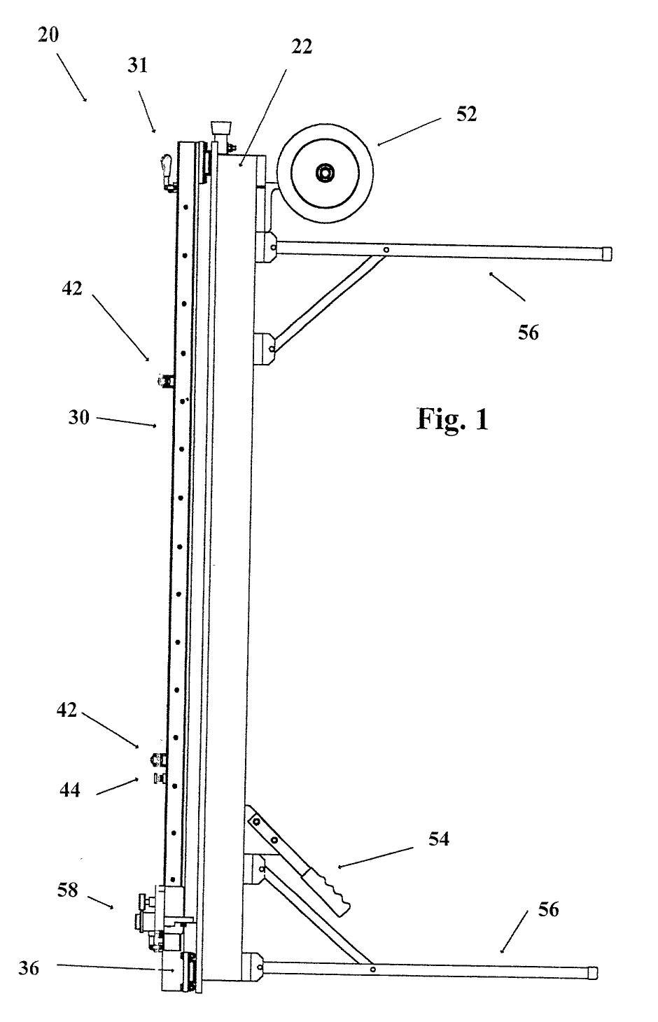

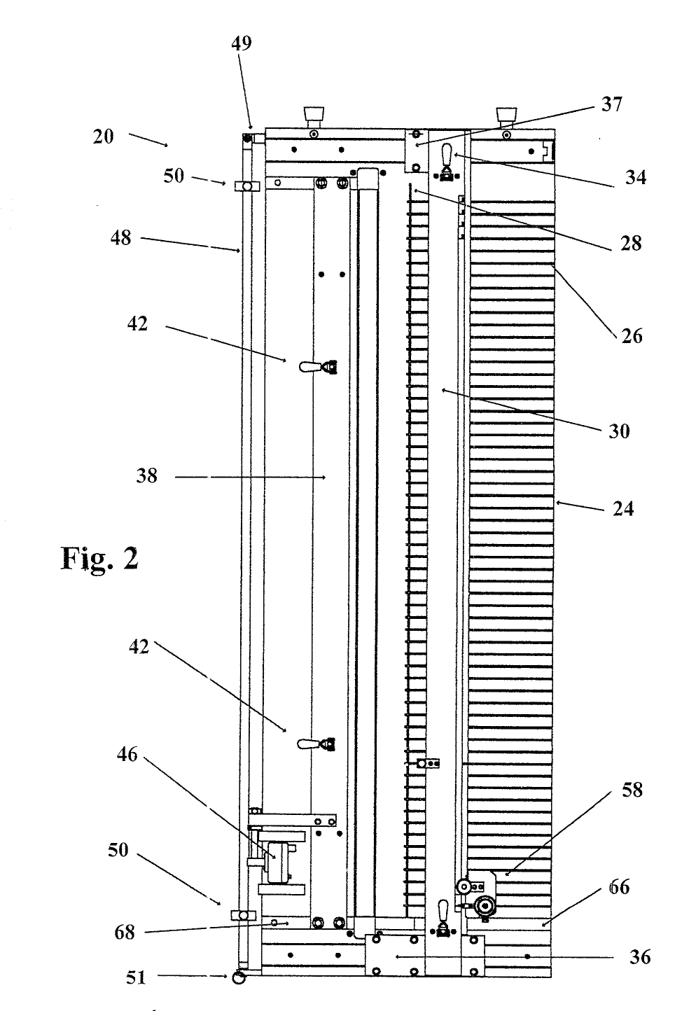

### DESCRIPTION OF THE PREFERRED EXECUTIONS

The invention has numerous applications including application to the task of cutting gel for stage and movie lighting and the like. The figures illustrate a preferred embodiment of the invention which has the following components.

20. cutting table assembly

22. frame May be of hardwood, metal, or other suitable material.

24. cutting table Preferably of half-inch polyvinyl chloride.

26. longitudinal grooves The cutting table is grooved at 1″ intervals, for example, to improve the cutting action of the cutter blade. It is important that the grooves not be wider than about one-eighth inch.

28. transverse groove The transverse groove improves the cutting action of the cutting blade when cutting transversely across the table. Again, a groove width no greater than about one-eighth inch is desired. The groove depth may be about one-eighth inch.

30. traveling cutter bridge Supports the cutter assembly 58 and retractable bridge idler roller 32. Preferably employs an aluminum “U” channel for stiffness and to guide the vertical reciprocal movement of the bridge idler roller.

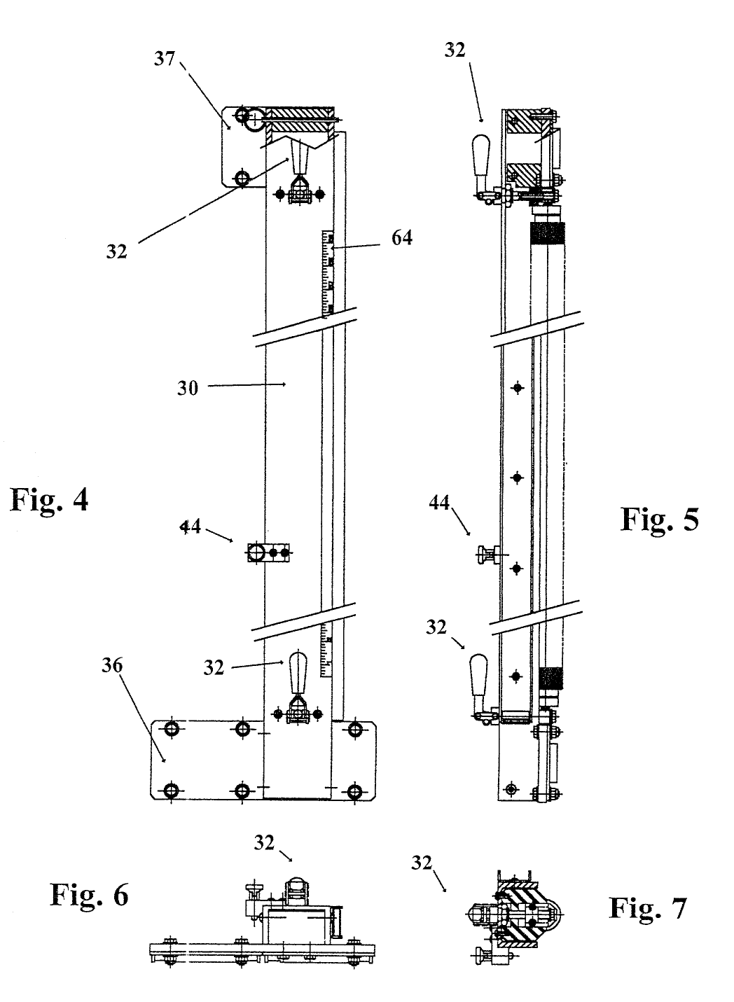

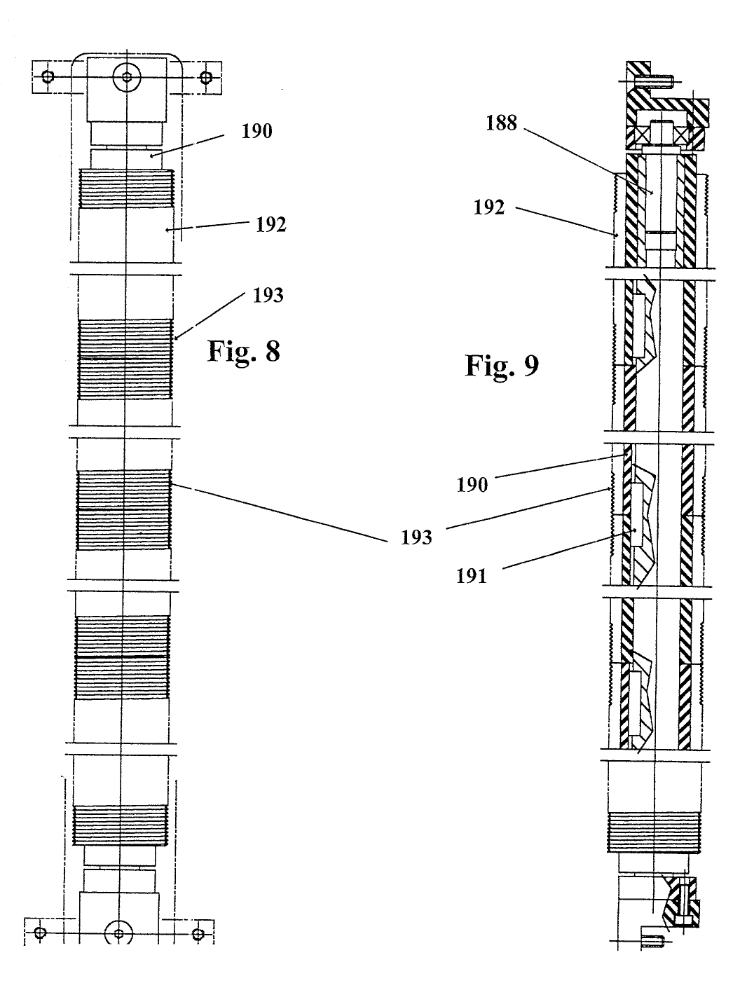

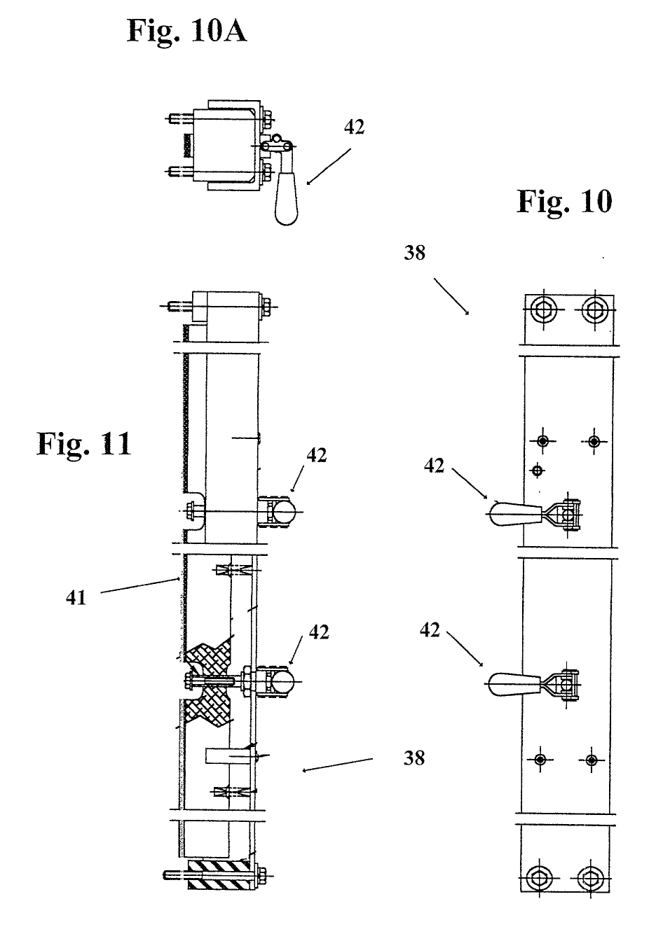

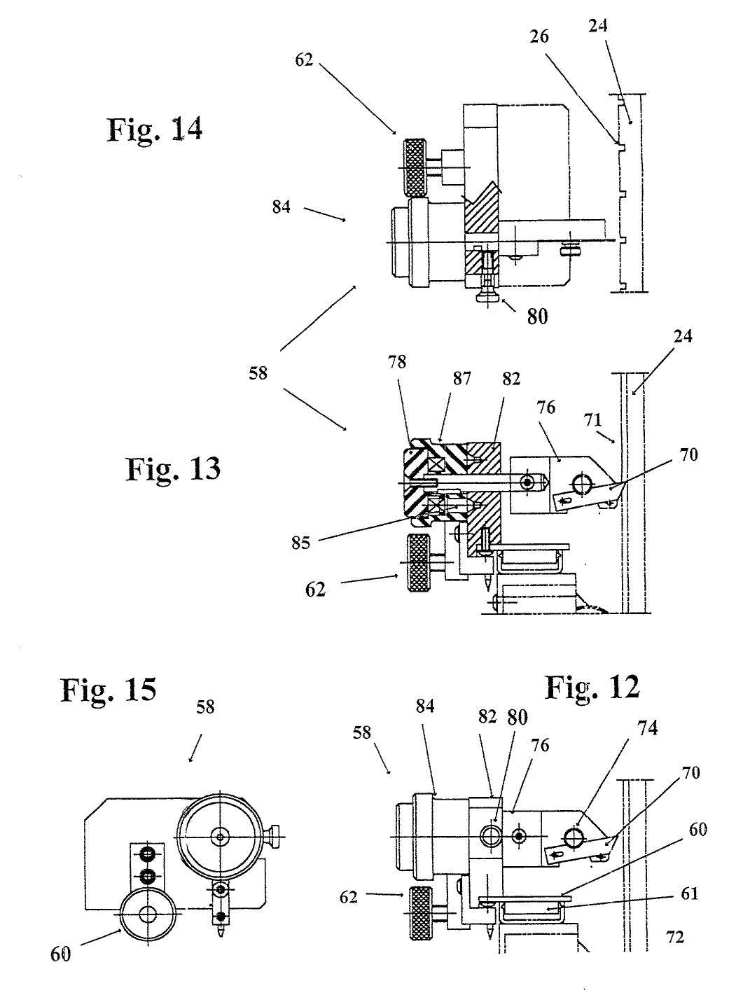

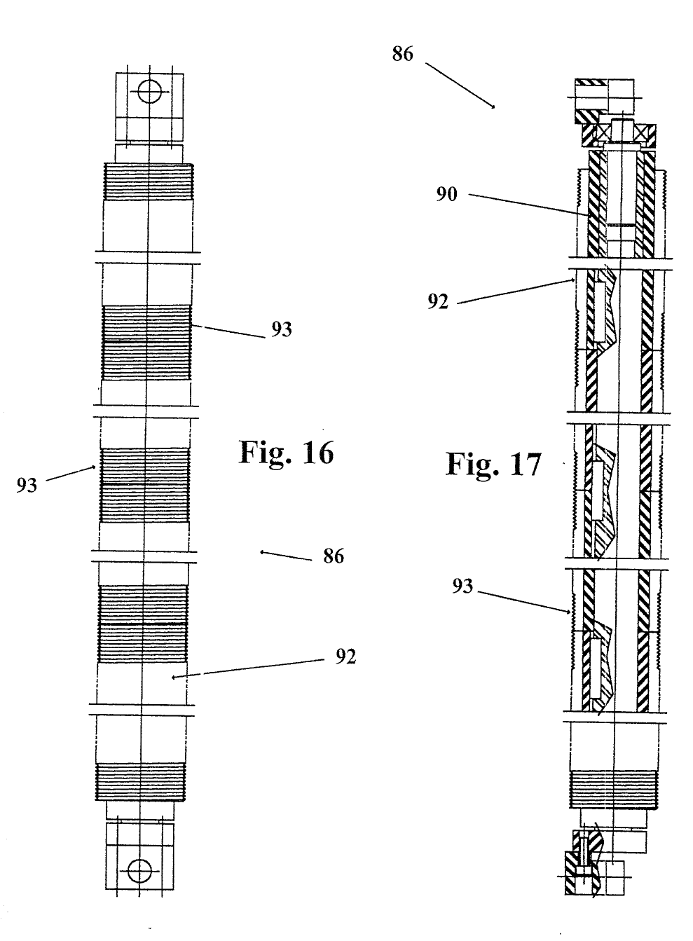

32. bridge idler roller See FIGS. 4-9. Supported within the cutter bridge 30 for selective manual movement between an operative descended position wherein it is in contact with table idler roller 86 and an inoperative elevated position. The bridge idler roller 32 is preferably comprised of a solid steel core 188 surrounded by a sleeve 190 of polyvinyl chloride which is coated with a layer 192 of Neoprene™. By way of example, the roller 188 may be approximately 1.5 inches thick. The Neoprene™ layer 192 may be approximately 0.190 inch. As shown in FIG. 5, the PVC sleeve 190 is preferably formed as a number of shorter lengths of stock which are interlocked to each other and to the shaft using keys (one be shown at 191). The Neoprene™ layer 192 has a series of circumferential grooves 193. In a preferred embodiment, the grooves are a 60 degree “V”, one-sixteenth inch pitch, 0.040 inch deep thread ground into the layer 192.

34. clamps Preferably conventional “De-sta-co” Series 602 straight line toggle clamps which engage the ends of the roller 32 and are used to manually raise and lower the idler bridge roller 32.

36 and 37. bearing packs Conventional bearings for supporting the cutter bridge 30 for longitudinal reciprocal movement. May be model FBW 50110 700L, manufactured by THK Co., Ltd.

38. clampbar assembly Used to clamp the gel sheet material to the upper surface of the cutting table 24. Preferably has a stiff aluminum “U”-channel support member for supporting a retractable clamp bar 40 for vertical reciprocal motion. See FIGS. 1040. clamp bar Preferably a rigid tube of rectangular cross-section with a soft resilient pad 41 on the bottom for engaging the gel without marring or scratching it.

42. clamps Preferably conventional “De-sta-co” Series 602 straight line toggle clamps which are used to manually raise and lower the clamp bar 40.

44. lock A spring-loaded detent which engages a cavity in the clamp bar assembly 38 to lock the traveling cutter bridge 30 to the clamp bar assembly 38.

46. counter assembly Pivotally mounted to the cutting table 24 for measuring lengths of sheet stock as it is drawn across the table 24.

48. gel support rod Joined to the frame 22 at pivot 49, and retained at its free end by a cotter pin 51, the rod swings away from the table 24 to permit loading of a roll of gel (not shown) on the rod 48. After loading of the roll, the cotter pin 51 is returned to secure the rod.

50. lockable collars A pair of collars with lock nuts are slideably retained on the rod 48 and are employed to retain a gel roll on the rod 48 after the roll is properly positioned on the rod 48.

52. wheels For transporting the cutting table assembly 20.

54. handles Used to support and guide the table assembly 20 when being wheeled about.

56. collapsible table leg assemblies

58. cutter assembly Used to cut the gel.

60. cutter carriage A conventional bearing pack 61 supports the cutter carriage for sliding transverse reciprocal movement on the traveling cutter bridge. May be model FBW 50110 700L, manufactured by THK Co., Ltd.

62. thumb wheel lock For locking the cutter assembly 58 at a predetermined position along the traveling cutter bridge 30.

64. width ruler For setting the width of a strip or section of gel to be cut, or specifying the location of a longitudinal gel cut. FIG. 4.

66. length ruler For setting the length of material to be cut.

68. guide Positions and helps to guide the sheet material as it is being aligned or fed.

70. cutter blade Employed to sever the gel. May be a No. 19 Exacto™ blade or other similar cutting blade. It is easily replace by aligning it on pin 72, and tightening a thumb nut 74 against it.

76. cutter blade holder Cutter blade holder 76 is spring biased for reciprocatory vertical movement. Has a finger actuator button 78 which, when depressed, causes the blade 70 to move to a stop position where is slightly below the top surface 71 of the cutting table 24.

80. locking pin Is spring loaded to snap into an opening in the cutter blade holder 76 to retain the holder in its descended position with the blade 70 in its operative cutting position.

82. cutter assembly mount Supports the cutter blade holder 76 for vertical reciprocatory movement.

84. blade detent sleeve assembly Carries a spring-loaded detent 85 which is adapted to click-stop in one of four detent dimples in the top surface of mount 82 (two of which are shown in FIG. 13) corresponding to blade orientations of forward, back, left and right (0, 180, 90, and 270 degrees). Sleeve 87 is also spring loaded. To rotate and lock the blade in any of the four described positions, the sleeve 87 is raised and rotated to the desired blade orientation corresponding to alignment of the detent in one of the four 90-spaced dimples. The sleeve assembly 84 is released to lock the blade 70 in the selected position.

86. table idler roller An idler roller which mates with the bridge roller 32 carried by the traveling cutter bridge 30 when the cutter bridge is abutted against the clamp bar assembly 38 acting as a stop. The table roller 86 like the bridge roller 32 is preferably comprised of a solid steel core 88 surrounded by a sleeve 90 of polyvinyl chloride which is coated with a layer 92 of Neoprene™. By way of example, the roller may be approximately 1.5 inches thick. The Neoprene™ layer 92 may be approximately 0.190 inch. As with roller 32, the PVC sleeve 90 may be formed as a number of shorter lengths of stock which are keyed together and to the shaft to prevent relative rotation.

The Neoprene™ layer 92 has a series of circumferential grooves 93. In a preferred embodiment, the grooves are a 60 degree “V”, one-sixteenth inch pitch, 0.040 inch deep thread ground into the layer 92. The construction of the rollers 32,86 has been found to be very important to cause the gel to come off its supply roller and travel smoothly across the table without slippage. Wandering of the gel has proven to be a challenge to overcome. I have found that the afore-described grooves on both rollers 32, 86 are very important to maintaining gel feed in a straight line.

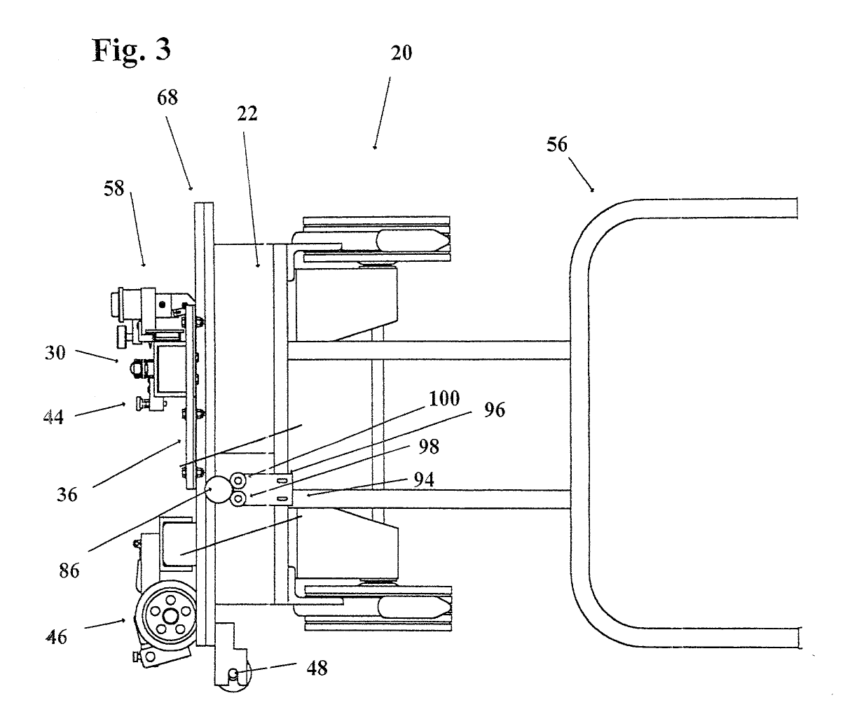

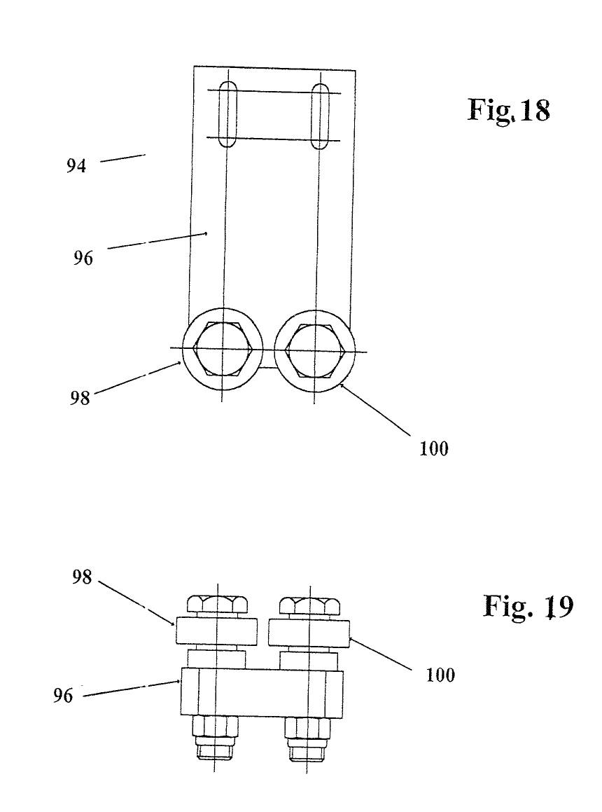

94. table idler roller supports See FIGS. 3, 18 and 19. The roller 86 is supported preferably at two spaced points along its length by vertically adjustable mounts 96 carrying a pair of spaced bearings 98, 100. The roller supports 94 have been found to be important to prevent sagging of the roller and consequent slipping or wandering of the sheet material as it is being pulled across the device cutter table assembly.

Operation

The cutting table assembly is versatile, having three main modes of operation.

Mode 1—Small Cuts

A gel roll (not shown) is slid onto rod 48 and the rod secured with cotter pin 51. The gel is then unwound and aligned with guide 68 which extends above the surface of the cutter table 24 a few inches. With the traveling cutter bridge 30 locked on the clamp bar assembly 38 and the table roller 86 aligned with bridge roller 32, but raised, the gel is threaded between the rollers 32 and 86, and manually pulled out to the desired length as measured against the length ruler 66. The clamp bar 40 is lowered using clamps 42 to secure the gel against the table 24.

To make five inch squares, for example, the user pulls the gel through the rollers 32, 86 to a mark of five inches on the length ruler 86, turns the blade 70 towards himself, and pushes down on the finger actuator button 78 on blade holder 76 to the stop position. The cutter bridge 30 is pulled toward the user. The blade 70 cuts the gel, riding in one of the longitudinal grooves 26, or between the grooves if not aligned with a groove. If a number of five-inch squares are desired, the user repeats the process every five inches along the width ruler 64 until the desired number of cuts has been made. The bridge 30 is then returned to one end of the transverse groove 28. The blade is rotated by lifting the sleeve assembly 84 and rotating the blade to the stop-click position corresponding to the correct blade orientation. The blade 70 is again pushed down to its limit position, and the cutter carriage 60 is moved along the cutter bridge 30 until all squares are severed and free. The result is a set of five-inch squares.

Mode 2—Large Cuts

Large cuts produce square or rectangular pieces of gel that cannot be made on the cutting table, such as one-foot by five-foot pieces. Large pieces such as this may be used to gel windows, for example.

To cut a one-foot by five-foot rectangular piece, for example, the user raises the clamp bar 40 and the bridge roller 32 and locks the bridge 30 against the clamp bar assembly 38, The cutter carriage 60 is positioned at 12 inches and locked there by tightening the thumb wheel lock 62. The blade 70 is rotated to a click-stop position on the width ruler 64 where it is facing away from the user, and locked down by releasing locking pin 80. Counter assembly 46 is pivoted down in contact with the gel and reset to zero.

With one hand on each side of the blade 70, the gel is grasped and pulled until the counter reads 5 feet. The blade 70 is unlocked, turned to the left, depressed, and moved to the left with the blade in transverse groove 28. The result will be a one-foot by five-foot strip of gel. To remove the waste, the blade is click-stopped to the right, depressed and moved to the extreme right, thereby severing a three-foot by five-foot piece of scrap gel.

Mode 3—Off-the-Roll Cuts

To make three more one-foot by five-foot strips from the scrap piece, the scrap piece is aligned with the edge guide 68, and the gel is threaded through the table roller 86 and bridge roller 32 (raising the bridge roller 32 if necessary). The cutter carriage 86 is set at 12 inches on the width ruler 64 and the blade rotated away from the user and locked down. The scrap gel piece is then pulled against the blade with one hand on each side of the blade, lifting the gel as it is pulled to assure that the blade stays in cutting engagement with the gel. When the scrap is pulled completely through, the result will be a second one-foot by five-foot strip. The process may be repeated to produce two more such strips.

Executions of the principles of the invention other than those described are within the scope of the present invention and are intended to be embraced by the following claims.

I claim:

1. Manually operable apparatus for cutting gel or other sheet material, comprising a cutting table and a longitudinally reciprocable traveling bridge mounting a transversely translatable cutter carriage supporting a cutter assembly for manually selective movement to any position on the cutting table.

2. The apparatus defined by claim 1 wherein said traveling bridge includes an idler roller.

3. The apparatus defined by claim 1 wherein said table mounts an idler roller.

4. The apparatus defined by claim 1 wherein said table and said traveling bridge mount mateable idler pinch rollers for guiding fed sheet material.

5. The apparatus defined by claim 1 wherein said bridge is supported at opposed ends by bearing packs.

6. The apparatus defined by claim 1 wherein said table has a plastic table top with a plurality of longitudinally spaced cutting grooves and a transversely spaced cutting groove.

7. The apparatus defined by claim 1 wherein said apparatus has transport wheels at one end and collapsible legs.

8. The apparatus defined by claim 1 wherein said apparatus includes a roll support shaft which is pivoted at one end for easy installation of a roll of sheet material.

9. The apparatus defined by claim 1 wherein said apparatus includes a counter for measuring a length of sheet material, said counter being mounted for pivotal movement between an inoperative position off the table and an operative position on the table.

10. Manually operable apparatus for cutting gel or other sheet material, comprising a cutting table and a longitudinally reciprocable traveling bridge mounting a transversely translatable cutter carriage supporting a cutter assembly for manually selective movement to any position on the cutting table, the cutter assembly including a cutter holder supported for rotation about a vertical axis and adapted to mount a replaceable cutter, said cutter holder being selectively lockable in 90-degree-spaced positions corresponding to cutter orientations in the direction of sheet material feed, or transverse thereto.

11. The apparatus defined by claim 10 wherein said cutter holder is vertically reciprocable between operative and inoperative cutter positions.

12. The apparatus defined by claim 11 wherein including means for locking said cutter holder in said operative cutter position.

13. The apparatus defined by claim 10 wherein said cutter is an Exacto™ blade.

14. The apparatus defined by claim 10 wherein said cutter holder is spring detented to lock in four click-stop positions.

15. Manually operable apparatus for cutting gel or other sheet material, comprising a cutting table and a reciprocable means mounting a cutter assembly for translatory movement across the table, the reciprocable means supporting an idler roller.

16. The apparatus defined by claim 15 including manually operable means for selectively moving said idler roller between a raised inoperative position above the table and a lowered operative position.

17. The apparatus defined by claim 15 wherein said roller comprises a core surrounded by a sleeve.

18. The apparatus defined by claim 17 wherein said sleeve has on its outer surface an array of spaced circumferential grooves.

19. The apparatus defined by claim 17 wherein said sleeve comprises a resin inner sleeve and a friction outer sleeve or layer.

20. The apparatus defined by claim 19 wherein said resin inner sleeve is composed of polyvinyl chloride and said outer sleeve or layer is composed of Neoprene™.

21. The apparatus defined by claim 20 wherein said outer sleeve or layer has on its outer surface an array of spaced circumferential grooves.

22. The apparatus defined by claim 21 wherein said grooves are approximately 60-degree “V”, approximately one-sixteenth inch pitch, approximately 0.040 inch deep threads.

23. Manually operable apparatus for cutting gel or other sheet material, comprising a cutting table and a manually translatable cutter assembly, the table supporting an idler roller, said roller comprising a core surrounded by a sleeve.

24. The apparatus defined by claim 23 wherein said sleeve has on its outer surface an array of spaced circumferential grooves.

25. The apparatus defined by claim 23 wherein said sleeve comprises a resin inner sleeve and a friction outer sleeve or layer.

26. The apparatus defined by claim 25 wherein said resin inner sleeve is composed of polyvinyl chloride and said outer sleeve or layer is composed of Neoprene™.

27. The apparatus defined by claim 26 wherein said outer sleeve or layer has on its outer surface an array of spaced circumferential grooves.

28. The apparatus defined by claim 27 wherein said grooves are approximately 60-degree “V”, approximately one-sixteenth inch pitch, approximately 0.040 inch deep threads.

29. Manually operable apparatus for cutting gel or other sheet material, comprising a cutting table and a longitudinally reciprocable traveling bridge mounting a cutter assembly, the bridge and the table supporting respective bridge and table idler rollers which mate when the bridge is positioned over the table roller.

30. The apparatus defined by claim 29 including manually operable means for selective moving said bridge roller between a raised inoperative position above the table and a lowered operative position.

31. The apparatus defined by claim 29 wherein said rollers each comprises a core surrounded by a sleeve.

32. The apparatus defined by claim 31 wherein said sleeve has on its outer surface an array of spaced circumferential grooves.

33. The apparatus defined by claim 31 wherein said sleeve comprises a resin inner sleeve and a friction outer sleeve or layer.

34. The apparatus defined by claim 33 wherein said resin inner sleeve is composed of polyvinyl chloride and said outer sleeve or layer is composed of Neoprene™.

35. The apparatus defined by claim 34 wherein said outer sleeve or layer has on its outer surface an array of spaced circumferential grooves.

36. The apparatus defined by claim 35 wherein said grooves are approximately 60-degree “V”, approximately one-sixteenth inch pitch, approximately 0.040 inch deep threads.

37. The apparatus defined by claim 36 wherein said rollers each having a friction surface and a predetermined mass such that a prescribed tension force on the sheet material is optimal in pulling the material straight through the rollers.

38. Manually operable apparatus for cutting gel or other sheet material, comprising a cutting table, a longitudinally reciprocable traveling bridge mounting a cutter assembly, and a sheet material clamping assembly.

39. The apparatus defined by claim 38, wherein said clamping assembly includes a clamping bar, and manually operable means for selectively moving said clamping bar between a raised inoperative position above the table and a lowered operative position in contact with the table.

40. The apparatus defined by claim 38 wherein said clamping bar has a resilient cushion mounted for engagement with the sheet material when the bar is in its lowered operative position.

41. The apparatus defined by claim 40 wherein said clamping bar comprises a rectangular bar.

42. The apparatus defined by claim 38 wherein said clamping bar serves as a stop for said traveling bridge.

43. The apparatus defined by claim 42 including means for locking said traveling bridge to said clamping assembly.

44. Manually operable and readily transportable apparatus for cutting gel or other sheet material, comprising a cutting table, means mounting a cutter assembly for movement to selected positions on the table, wheel means beneath one end of the table, and a set of collapsible table legs.

45. A method for cutting gel or other sheet material, comprising:
a. feeding sheet material over a cutting table and through a pair of pinch rollers;
b. translating a cutter assembly transversely on the table to a position corresponding to a predetermined sheet material width desired to be cut; and
c. manually pulling the material between the rollers and against the cutter to cut the material to said predetermined width,
d. said rollers each having a friction surface and a predetermined mass such that a prescribed tension force on the sheet material is optimal in pulling the material straight through the rollers.

46. The method defined claim 45 wherein said rollers each comprises a solid shaft surrounded by a sleeve.

47. The apparatus defined by claim 46 wherein said sleeve has on its outer surface an array of spaced circumferential grooves.

48. The apparatus defined by claim 46 wherein said sleeve comprises a resin inner sleeve and a friction outer sleeve or layer.

49. The apparatus defined by claim 48 wherein said resin inner sleeve is composed of polyvinyl chloride and said outer sleeve or layer is composed of Neoprene™.

50. The apparatus defined by claim 49 wherein said outer sleeve or layer has on its outer surface an array of spaced circumferential grooves.

51. The apparatus defined by claim 50 wherein said grooves are approximately 60-degree “V”, approximately one-sixteenth inch pitch, approximately 0.040 inch deep threads.

52. A method for cutting gel or other sheet material, comprising:
a. mounting a cutter on a longitudinally reciprocal traveling bridge for transverse translatory movement along the bridge;
b. feeding sheet material over a cutting table and beneath the bridge;
c. translating the cutter transversely along the bridge to a position corresponding to a predetermined sheet material strip width desired to be cut;
d. orienting the cutter to face opposite to the direction of material movement;
e. manually pulling the material against the cutter to cut the material to said predetermined strip width;
f. rotating the cutter 90 degrees and locking it;
g. translating the cutter transversely along the carriage to sever and free a strip of material of said predetermined width.

53. The method defined by claim 52 wherein said sheet material is clamped before the strip is severed.

54. A method for manually cutting gel or other sheet material into rectangular pieces, comprising:
a. on a cutting table, mounting a cutter on a longitudinally reciprocal traveling bridge for transverse translatory movement along the bridge;
b. feeding sheet material into a desired position on the cutting table;
c. clamping the material on the table to hold it stationary during the cutting operation; and
d. making a series of cutting actions with the cutter oriented each time in the direction of cutter movement and locked, the cutting actions including moving the cutter transversely along the bridge with the bridge position fixed, and moving the bridge with the cutter position fixed on the bridge.

55. The method defined by claim 54 wherein said cutter comprises part of a cutter assembly, the cutter assembly including a cutter holder supported for rotation about a vertical axis and adapted to mount a replaceable cutter, said cutter holder being selectively lockable in 90-degree-spaced positions corresponding to cutter orientations in the direction of sheet material feed, or transverse thereto.

56. The method defined by claim 55 wherein said cutter holder is vertically reciprocable between operative and inoperative cutter positions.

57. The apparatus defined by claim 56 including means for locking said cutter holder in said operative cutter position.

58. The apparatus defined by claim 54 wherein said cutter is an Exacto™ blade.

59. The apparatus defined by claim 54 wherein said cutter holder is spring detented to lock in four click-stop positions.

60. The apparatus defined by claim 3 including a vertically adjustable roller support located between the ends of the table idler roller.

61. The apparatus defined by claim 4 including a vertically adjustable roller support located between the ends of the table idler roller.

62. The apparatus defined by claim 23 including a vertically adjustable roller support located between the ends of the table idler roller.

63. The apparatus defined by claim 29 including a vertically adjustable roller support located between the ends of the table idler roller.

64. The apparatus defined by claim 37 including a vertically adjustable roller support located between the ends of the table idler roller.
